(19) United States
(12) Patent Application Publication
(10) Pub. No.: US 2004/0263777 A1
(43) Pub. Date: Dec. 30, 2004

(54) Photochromic light-polarizing lens for sunglass and method for producing the same

(76) Inventor: Su-Jin Kim, Seoul (KR)

Correspondence Address: D. PETER HOCHBERG CO. L.P.A., 1940 EAST 6TH STREET, CLEVELAND, OH, 44114, US

(21) Appl. No.: 10/488,286

(22) PCT Filed: Aug. 30, 2002
(86) PCT No.: PCT/KR02/01647

(30) Foreign Application Priority Data
Aug. 30, 2001 (KR) 2001/0053071

(51) Int. Cl. G02C 7/10

(52) U.S. Cl. 351/163

(57) ABSTRACT

The present invention relates to a photo-chromic light-polarizing lens, in which the defects respectively of conventional polarizing lenses and photo-chromic lenses are remedied to a great extent by mutual supplement and correction, and also the method for its production. By blocking such interfering lights as are caused by reflection or refraction, against which conventional sunglasses or conventional photo-chromic lenses of prior arts are entirely helpless, the lens of the present invention enables people to see things with comfortable clarity in such dark places as a tunnel or insufficiently lighted room. The present invention also provides a powered sunglass lens for weak-sighted people so that sunglasses with power will be made available to them for reasonably cheap prices through mass production.

### CROSS REFERENCE TO RELATED APPLICATIONS

This application is the National Stage of International Application No. PCT/KR02/01647 filed Aug. 30, 2002, which claims priority from Korean application serial no. 10-2001-0053071, filed Aug. 30, 2001.

### BACKGROUND OF THE INVENTION

1. Technical Field

The present invention relates to a novel photochromic light-polarizing power lens and more particularly to a novel photochromic light-polarizing lens and a producing method thereof, wherein the defects respectively of conventional polarizing lenses and conventional photochromic lenses of prior arts have been overcome to a great extent by making them supplement and remedy each other, while retaining their respective advantages intact.

2. Prior Art

How much tone of color should be applied to a pair of sunglasses in order that the eyes may not get dazzled by a shining light or objects in the dark may not appear gloomy? No correct answer seems available. For, if shade were applied to the sunglasses lest brilliance should dazzle the eye, objects in a poorly lit place would naturally look the darker, while if, conversely, application of color tone were done to a degree not to render things in a dusky place too dark, the color tone has to be thin and inadequate at lighter places and the glasses could not serve as ones protecting the eyes against the dazzling sunlight. A pair of sunglasses with a fixed tone of color could not prove satisfactory in both cases.

Ordinary sunglasses are used, as well known today, for the merits including their function to protection of the eyes against the dazzling by the effects of the color applied to the glass or other transparent plastic material, and also their function to keep the ultraviolet rays of the sunlight from reaching the eye balls by virtue of the ultra-violet ray absorbent mixed in the lens.

In the case of colored sunglasses which have a demerit of making things at indoors or in a darker place like a tunnel look even darker, and, thereupon, photochromic sunglasses have appeared on sale. In such photochromic sunglasses the lenses changed darker at the outdoors by virtue of an act of the photochromic chemical the lenses are made to contain in them in reaction to the ultraviolet rays of the sunlight, while the color of the lenses grows thin indoors or in a tunnel where are no ultraviolet rays.

However, these sunglasses, regardless of whether ordinarily colored ones or photo-chromic sunglasses can not block the penetration of the dazzling polarized reflective rays, i.e. the interfering light rays (traverse waves) which reach within the range of eye sight from the roads, vehicles, and other reflectors, while getting reflected and refracted.

Meanwhile, the light-polarizing lens has not merely the functions which the photochromic sunglass lenses have but, also such other effects such as blocking, by virtue of the built-in perpendicular retiform polarizer between the lenses, the dazzling polarized transverse waves reaching, reflected and refracted, within the range of view from the roads, vehicles, and other reflectors, and has for these additional effects stepped into the limelight as a material a pace further advanced from ordinary sunglass lenses or photochromic sunglass lenses.

However, light-polarizing lenses have essentially to undergo dyeing of the PVA (polyvinyl-alchohol) with a certain concentration of iodine while in the stage of its production, and because a color is fixed as a result of the dyeing, it has a demerit of feeling objects uncomfortably dark when they are seen indoors or in a tunnel.

The present invention relates to a method for economical mass production of photo-chromic light-polarizing sunglass lenses having high quality and value-added and such sunglass lenses produced by said method. Sunglasses are worn to protect eyes against dazzling lights or to block harmful ultraviolet rays, etc., and among the generally known sunglass lenses are (1) colored glass lenses, (2) colored plastic lenses, (3) photo-chromic colored glass lenses (US Corning Glassworks' make), (4) polarized glass lenses (US Polaroid Corp's make), (5) polarizing cellulose acetate film (Japan's Kuraray's make), etc. in use for the present.

Of these, the materials for (1) and (2) above each have only effects of making things look darker and of protection against ultraviolet rays by the dyed colors, and, therefore, is usable for glasses for wear in the open where the sun shines, while it makes objects appear too dark indoors or in a tunnel. Especially when driving a car this may prove even somewhat dangerous. To remedy this, photo-chromic colored lenses were invented and are on sale on the market, but they have a demerit in inability to block such dazzling polarized reflective light, i.e. the transverse waves reaching out, reflected and refracted, from the roads, automobiles, and other reflectors of light.

The materials of (4) and (5) above each have, in addition to the merits of the above (1), (2), and (3), such other capabilities as of blocking the dazzling polarized transverse waves reaching, reflected or refracted, from such reflectors as the roads, automobiles, etc. by virtue of the perpendicular retiform polarizer built-in between the lenses, whereby they are regarded also as a one step further advanced product, compared with the above (1), (2), and (3).

The light-polarizing lens of the above (3) has a demerit, however, in that things indoors or in a tunnel look dark, because it has to undergo the process of getting the PVA (polyvinylalchohol) dyed with a certain concentration of iodine and, as a result, the color cannot but be fixed that time.

To repeat, the present invention was conceived of with a view to arriving at a new invention by having both light-polarizing lenses and photo-chromic lenses mutually set off and correct their respective demerits while getting their respective merits mutually supplemented.

In other words, the present invention relates to a photo-chromic light-polarizing sunglass lens and a method for its production, said lens having the effect of blocking the dazzling traverse waves of polarized light, which reaches out, reflected and refracted, from the roads, vehicles, and other reflectors, and which the material in the above (1) and (2) can not block, and also having the faculty of not making objects indoors or in a tunnel look dark or dusky.

Clearly to comprehend the present invention it is necessary to have knowledge of two aspects of matters, i.e. photochromism and polarazation of light. Below, photochromism is described first, and polarization of light, next.

Generally, the phenomenon that a material revertibly changes its hue in reaction to a stimulus from an external source is termed chromism, and it is known that such external sources of stimuli include heat, light, electricity, solvents, etc.

The kinds of chromism include thermochromism (e.g. dyestuffs sensitive to heat), in which the hues revertibly change in reaction of heat; photochromism (e.g. photochromic glass), in which the hues revertibly change in reaction to light, especially to ultraviolet rays; electrochromism (e.g. liquid crystal display), in which the hues revertibly change in reaction to electricity; solvatochromism (e.g. pH indicators), in which the hues revertibly change in reaction to solvents); etc. Of these several, photochromism, because in it the hues revertibly change, depending upon the existence or absence of shining of lights, can be of use in production of photochromic plastic and lenses, for example, ophthalmic materials like ophthalmic lenses, optical materials, sunglass lenses, skier's goggles, visors, camera lenses, and filters. The term “optical materials,” used here includes lenses and other transparent materials.

Many a research has been made of potochromic materials, whose hues revertibly change in reaction to shining or blocking of light rays. Such spiro(indoline)naphthoxazine compounds as have been disclosed by KPs 0142804 and 0145266, and especially by U.S. Pat. Nos. 3,562,172; 3,578,602; 4,215,010; and 4,342,668 are found especially useful in production of sunglasses and ophthalmic lenses. Photochromic compounds in the state of solution or dispersion solution, among the crystal or transparent media, instantly turn blue from no-color when they are exposed to sun light or ultraviolet rays, but revert to their original hues when placed in a dark place or if left in a state where there is no influence of ultraviolet rays.

Of these, spirobenzopyran compounds, having such properties as photochromism, photo conductivity, photosensitivity, along with optical memory property, are promising compounds for wide application to an indicating element or optical element, too. In this connection a group of photochromic pyran derivatives starting with particular benzopyran and naphthopyran (U.S. Pat. Nos. 3,567,605 and 5,238,981), a group of phototropic spiropyran derivatives (Eps Pub. Nos. 246,114 and 250,193), in which a spiroadamantane group is bonded at position 2 of benzopyran or naphthopyran link, and spirooxazine compounds (JP Pub. No. Hei-3-81278; KP Pub. No. 92-8620; EPs 0432841 A-2, 0600669 A1, and 0600688 A1) are known.

Spirobenzopyran compounds are more advantageous than spirooxazine in that they are simpler to synthesize. Compounds commonly known of including spirobenzopyran compounds, in which the nitro, sulfonic, and hydroxy groups have been substituted (JPs Pub. Nos. Hei-3-20626, Hei-2-264246, Hei-4-116545, and Hei-4-116546, EPs. 014476 A1, 0483542 A1, 0483542 A1, and 0502506 A1).

To turn the spiro(indoline)naphthoxazine and benzopyran compounds suitable for the present invention into high polymers for use as photochromic products, spiro(indoline)naphthoxazine or spirobenzopyrene derivatives are added to monomers to form the copolymers, or they are added direct to high polymers and fused into ones. At this time the heat-resistance at the temperature at the time of the formation process, the kinds of the high polymers to be used, compatibility, photo stabilizers, antioxidants, and other additives, the temperature of air, and many other factors have to be taken into account. The high polymeric materials used at this time include a wide range of materials such as compounds of polymetalacryl, cellulose, polyvinylbutyral, polyester, and polystyrene groups. As cases where kinds of spiro(indoline)naphthoxazine were used for photochromic products can be named the instances of use of them in plastic sunglasses, skier's goggles, visors, windows for cars and buildings, and the like. Spiro benzopyran compounds with photochromic properties can be represented by the following chemical formulas.

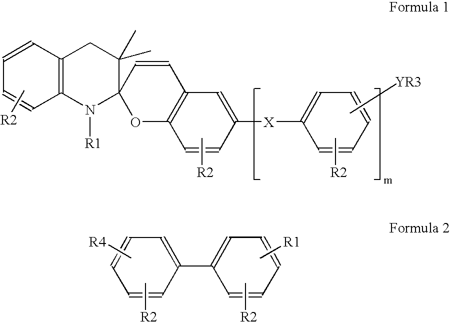

In the above formula, R1 stands for hydrogen atoms; alkyl with 1˜22 carbons; alkyl with 1˜22 carbons substituted with hydrogen, halogen group, hydroxy group, glycidoxy group, amine group, vinyl group, epoxy group, methacryl group, acryl group, amino group or mercapto group; alkenyl with 1˜22 carbons; alkoxy with 1˜22 carbons; substituted or unsubstituted phenyl; or phenylalkyl;

R2 stands for hydrogen atoms; halogen group; cyano group; carboxy group; substituted amino group; nitro group; alkyl having 1˜10 carbons; alkoxy having 1˜10 carbons; alkylcarboxy group having 1˜10 carbons; phenyl group; or phenyl group substituted with R1;

—X stands for —CO—, —CO2. —S—, —SO2-, —C;

C—, —O—, —C(R1)2-, —C(R1)=C(R1)-, N═N—, —NR1;

Y is either same as X, or is either a substituted group of one or two of (CH2)n, —[C(R1)(R2)-]n-, —[X—C(R2)2-C(R1)2-]n-;

m is a number 1˜10; and

n is a number 0˜20.

In the above formula 1, as examples of substituted or unsubstituted alkyl group can be named such hydrocarbon groups as the groups of methyl, ethyl, n-propyl, isopropyl, n-butyl, isobutyl, sec-butyl, t-butyl, n-pentyl, isopentyl, neopentyl, 1,4-dimethylpropyl, n-hexyl, cyclohexyl, 1,3-dimethylbutyl, 1-isopropylpropyl, 1,2-diethyl-butyl, n-heptyl, 1,4-dimethylpentyl, 2-methyl-1-isopropylpropyl, 1-ethyl-3-methyl-butyl, n-octyl, 2-ethylhexyl, 3-ethyl-1-isopropylbutyl, 2-methyl-1-isopropylbutyl, 1-t-butyl-2-meth-ylpropyl, and n-nonyl; such alkoxyalkyl groups as the groups of methoxymethyl, meth-oxyethyl, ethoxyethyl, propoxyethyl, butoxyethyl, methoxyethoxyethyl, ethoxyeth-oxyethyl, dimethoxymethyl, diethoxymethyl, dimethyl, and diethoxyethyl; and such halogenated alkyl groups of chloromethyl, 2,2,2-trichloroethyl, trifluoromethyl, and 1,1,1,3,3,3-hexafluoro-2-propyl.

R1 is alkyl having 10 or fewer carbons, while X is —CO— or —S—, and Y is preferably a chemical compound (1), which is —CP—.

The spirobenzopyran compound in formula 1 is produced by what has been reacted of the above formula 1 and 2 in a solution selected from a group consisting of tetrahydrofuran, toluene, a low class alcohol having from 1 to 10 carbons, acetonitrile, acetone, dimethyl-sulfoxide (DMSO), dimethylformamide (DMF), α-methyl-naphthalene, chloronaphthalene, diphenylethane, ethylenegrycol, quinoline, dichlorobenzene, dichlorotoluene, propylene carbonate, sulforane, and xylene or a mixture of one or more of them at a temperature in the range of −5° C. to 100° C. for five days.

R3 is either hydrogen atoms, or halogen, hydroxy, glycydoxy, amine, epoxy, methacryl, acryl, or mercapto group, while R4 is either a halogen, hydroxy, carboxylic acid, or aldehyde group.

In the above method, the reaction temperature can be variously set within the range given above, according to the reactivity of the respective bases.

The compounds given in the above formula 1 and 2 can be purchased at the market or manufactured by the commonly known methods (KP Application No. 98-18556). In production of the chemical compounds listed in Formula 1 above, for instance, [6-phenylcarbonyl-1′,3′,3′-trimethylspiro[2H-1-bezopyran-2,2′-indoline]-4″-yl]4-(4′-octyloxyphenyl)benzoate (PCSBPI-OOBP) is made by reacting [6-phenylcarbonyl-1′,3′,3′-trimethylspiro[2H-1-benzopyran-2.2′-indoline]4″-yl] with 4′-octyloxy-4-bi-phenyl carboxylic acid. At this time, as the reaction solvent such ordinary organic solvents as, for example, dichloromethane, chloroform, etc. can be used, and in order to stimulate the reaction an acid or one to three kinds of compounds selected from base catalysts, e.g. dicyclorohexylcarbodiimid (DCC), 4-(dimethylamino)piridine (DMAP) and amine, etc. can be added. The reaction temperature is −5° C. to 100° C., and the time, 30 minutes to about five days. The spirobenzopyran compound produced this way carries a photochromic property, turning blue if irradiated with ultraviolet rays with a wavelength in the level of 200˜340 nM and returning colorless as ever, if irradiated with visible light.

In especial, as spiro(indoline)naphthoxazine or spirobenzopyran compounds can be dissolved in such ordinary organic solvents as benzene, toluene, chloroform, ethyl-acetate, methylethylketone, acetone, ethylalcohol, methyalcohol, acetonitrile, tetrahydrofuran, dioxane, methylether of ethyleneglycol, dimethylformamide, dimethylsulphoxide, methylcellosolve, morpholine, and ethylglycol, they can be mixed into polymers used in production of transparent plastic and lenses, e.g. such ophthalmic and optical materials as ophthalmic lenses, sunglass lenses, skier's goggles, visors, camera lenses, and filters. The “optical materials” include lenses and transparent objects. The applicable substances include, e.g. polyol (alkylcarbonate), polymers of monomers, poly-acrylate, poly(akylacrylate), e.g. PMMA-polymethylmethacrylate, MMA-methylmeth-acrylate, polycarbonate, polyethylene terephthalate, polystyrene, poly(styrene methyl methacrylate) copolymers, poly(styrene-acrylonitrile) copolymers, and polyvinylbutyral. Transparent copolymers and mixtures of transparent copolymers are also suitable as applicable substances.

As for the quantity of the solvent used in dissolving the photo-chromic compound, it has to be a quantity enough to obtain photo-chromic product to provide the host with sufficient photo-chromic compound, when it is applied to a host. The quantity of the photo-chromic compound or the compound containing it to be applied to or mixed into a host is not critical, but can vary according to the desired intensity of the color of the composition at the time of irradiation with light and the method adopted for mixing or applying the photo-chromic compound. Generally, the more chemicals are added to, the thicker the hues get. Such a quantity is generally called the amount of photochromism. Generally, the amount of the photo-chromic compound mixed into a host is about 0.01˜20 weight % of the weight of the host, and ordinarily it is 0.05˜10 weight %. In other words, the amount of the photo-chromic compound used to produce the photo-chromic effects is within the range of about 1˜10 mg for the photo-chromic reagent to the surface area (cm²) of the host, regardless of its thickness. Accordingly, the photo-chromic com-pound exists in high density in a thin sample, film, or coating, the thinner in the thicker sample.

Spiro(indoline)naphthoxazine compounds or spirobenzopyran compounds can be dissolved in a colorless or transparent solution of a transparent polymer, copolymer, or an organic solvent made from a mixture of these transparent polymers, e.g. there is a polymer of a transparent host dissolved in one or more of the organic solvents mentioned above. Examples include solutions of polyvinyl acetate-acetone, nitrocellulose-acetonitrile, polyvinyl chloride-methylethylketone, polymethyl methacrylate-acetone, cellulose acetate-dimethylformamide, polyvinylpyrolydone-acetonitrle, polystyrene-benzene, and ethylcellulose-methylchloride.

These photo-chromic solutions or compositions are applied to such transparent supports as paper of cellulose triacetate, polyethylene terephthalate or barium oxide, and are dried to obtain a photo-chromic substance, which turns blue when shone by ultraviolet rays but returns colorless when sources of ultraviolet rays are removed.

Spiro(indoline)naphthoxazine or spirobenzopyrene compounds are photochromic com-pounds, but compositions containing them can either be applied to, or mixed into, transparent solid polymeric organic materials, e.g. synthetic plastic objects. The objects to which such photo-chromic materials are to be applied are preferably optically clear materials such as those useful as ophthalmic materials like ophthalmic lenses, windows, and windshield glass, for example. Such preferable objects containing photo-chromic compounds can be used advantageously in production of photo-chromic plastic film, sheets, and lenses, for example, sunglass lenses, skier's goggles, visors, camera lenses, and filters. The term “optical materials” used herein includes lenses and transparent objects.

The transparent objects for application to the photo-chromic light-polarizing sunglass lenses of the present invention include, for example, a copolymer of polyol(arylcarbonate)monomers, polyacrylate, poly(alkylacrylate), for example, polymethyl meth-acrylate, cellulose acetate, cellulose triacetate, cellulose acetate propionate, cellulose acetate butyrate, poly(vinyl acetate), poly(vinyl alcohol)polyurethane, polycarbonate, polyethyrene terephthalate, polystyrene, poly(styrene-methyl methacrylate) copoly-mers, poly(styrene-acrylonitrile) copolymers, and polyvinyl butyral. Transparent co-polymers and mixtures of such transparent copolymers can also serve as objects for application. Preferable for such objects as for application to are optically transparent polymeric organic materials made from such polycarbonates as poly{4,4-dioxydi-phenyl-2,2-propane (on sale by the name of LEXAN)}; polymethylmethacrylate (on sale as PLEXIGLAS); copolymers of polyol (arylcarbonate) (on sale as CR-39), particularly diethyleneglycol bis (alyl carbonate) and, e.g. vinyl acetate and its copolymers, e.g. 80%˜90% diethylene glycol bis (aryl carbonate) and 10%˜20% vinyl acetate copoly-mers; in especial, 80%˜85% bis (aryl carbonate) and 15%˜20% vinyl acetate, cellulose acetate, cellulose propionate, cellulose butyrate, polystyrene and methylmethacrylate, vinyl acetate and acrylonitrile, and its copolymers, and cellulose acetateburyrate.

The polyol(aryl carbonate) which can be polymerized to form a transparent photo-chromic lens is the polyol carbonate of either aliphatic or aromatic liquid polyol with a straight chain or a forked chain, viz. an aliphatic glycol bis(aryl carbonate) compound or an alkylidene bisphenol bis(alkyl carbonate) compound. These monomers can be described as polyol, viz. unsaturated poly carbonate of glycol. They can be produced by a method publicly known in this field, e.g. those in U.S. Pat. Nos. 2,370,567 and 2,403,113.

Second, polarization is going to be described below:

Natural light with an plane of oscillation of all the 360°-direction shoots into the eyesight in the form of blinding reflection, when it gets reflected on the surface of glass or water at 50° or at a greater angle. Such polarization can be found in the dazzling reflection either on the surface of roads at bright daylight, on the rainwater on the road on a rainy day, or on the rear window of a car running in front. Or else, it can be the dazzling reflection of the bright sunrays on the surface of the waters seen when one watches the buoy while angling fish, too. All these reflected sun rays, being polarized light, can not be shut out merely by sunglasses, made only by coloring, or ordinary photo-chromic lenses, and only such photo-chromic light-polarizing lenses as have been made to polarize lights in the perpendicular direction can block such blinding reflections (high school text book on physics-1, pd. by Dong-A Publishing Co., Ltd.).

In what is termed the “polarizing film” those linear polarizer, of all the various polarizing elements, are the most commonly made use of as polarizer, which make it possible to acquire the polarized light alone by allowing such light, of all the natural light having oscillation surfaces in all the 360° directions, as has oscillation only in certain directions, to pass through, while absorbing all the rest of light rays. The production of polarizer can be done by the existing publicly known methods or by what has been disclosed in KP 10-0263821. At present on sale on the market is what is called “polarizing plastic thin film,” a lamination type, which is formed of PVA (polyvinyl-alcohol) film dyed with iodine as the basic material film and of CTA (cellulose triacetate) film, which is better stable than the PVA in measurements and against strain or wear, as protective film for the basic material film. PVA (polyvinylalcohol) film, which is only dyed with iodine and treated with polarizing elements is extremely weak in resistance against both water and wear, and so it is used only after lamination with CTA on both sides like CTA/PVA/CT. Yet such polarizing cellulose acetate films are of thin sheets, and are mainly used for industrial purposes in computers, liquid crystal gauge boards, liquid crystal display screens of hand-carried phones, etc., and, if only rarely, also for polarizing sun-glass lenses of no power.

Now light polarizing sunglass lenses, too, like ordinary colored sunglass lenses, inevitably have to undergo the process of getting the PVA dyed with a certain thickness of iodine, but as a result of such a dyeing treatment a chromaticity is fixed, entailing a phenomenon that indoors or in a tunnel objects look dark and gloomy, through such lenses.

To remedy this sort of defects of the existing sunglasses the present invention provides a photo-chromic lens, in which, basically, the PVA which serves as polarizer is dyed sufficiently thinly at the time of the dyeing treatment, lest objects should be seen dark or gloomy indoors, and a transparent copolymer or a mixture of copolymers mixed with a certain amount of photo-chromic materials which can react to ultraviolet rays and darken objects in bright sunlight, e.g. MMA (methyl methacrylate) or the like, is laminated with in the front (layer) nearer to the source of light to render the color thicker when ultraviolet rays irradiate.

Meanwhile, although a photo-chromic light polarizing lens has far better functions and far greater capacities than ordinary sunglasses by virtue of its built-in polarizer in the form of a perpendicular reticulum, which can shut out the dazzling traverse waves of interfering rays shot from the roads, vehicles, and other reflectors, hardly blocked off by ordinary sunglasses, no method has so far been proposed for mass production of such photo-chromic light-polarizing sunglasses of power suitable for weak-sighted people for supply at reasonable prices.

Until present light-polarizing sunglasses of no power have been produced by various methods and placed on sale at relatively low prices, and weak-sighted people who need glasses for all time, too, can use sunglasses of power, but it has been unusually extremely difficult to acquire a pair of polarizing glasses of power, which can shut off the reflected light, too.

Attempts to provide light-polarizing lenses of power have been confined to glass lenses, and because of the difficulty in grinding and polishing glass almost forbiddingly high prices are charged for purchase of the desired products for the present. An expedient for a weak-sighted person to wear polarizing sunglasses is, at best, to clip such glasses on his all-time spectacles of power.

The present invention relates to a photo-chromic light-polarizing lens of power and a relatively easy and simple method for its mass production. Thanks to this method for mass production it will be made possible to supply sunglasses of power to all the people in the world who need such sunglasses for incomparably cheaper prices than now.

### SUMMARY OF INVENTION

The present invention relates to a photo-chromic light-polarizing sunglass lens of power for the weak-sighted person, along with a method for its production, said lens being one which can block the dazzling reflective sun lights, refracted, from the roads, vehicles, and other reflecting objects coming into the eyesight, which no ordinary sunglasses or photo-chromic sunglass lenses of prior arts can block, while rendering things not uncomfortably dark or gloomy even indoors or in a tunnel.

In the present invention, while making researches to solve the problems with the prior arts in the field, the inventors hit upon the idea that it would be possible to produce such ophthalmic materials as photo-chromic optical lenses, sunglasses, skier's goggles, visors, camera lenses, and filters by mixing such spiro(indoline)naphthoxazine compounds or spiro-benzopyrene compounds as have been publicly known through KPs 0142804 and 0145266, U.S. Pat. Nos. 3,562,172, 3,578,602, and 4,342,668 with transparent polymers, copolymers, and mixtures of such copolymers, whereupon, as a result, to attain to the present invention of a photo-chromic light-polarizing sunglass lens of power.

In the polarizing film those linear polarizer, of all the various polarizer, are the most commonly used polarizing elements, which make it possible to attain only the polarized light by allowing such light, of all the natural light having oscillation surfaces in all the 360° directions, as has oscillation only in certain directions, to pass through, while absorbing all the other light rays. The production of light-polarizing elements can be done by the existing publicly known methods or by what has been disclosed in KP 10-0263821. At present on sale on the market is what is called “light polarizing plast thin film,” a lamination type, which is formed of PVA (polyvinyl-alcohol) film dyed with iodine as the basic material film and of CTA (cellulose triacetate) film, which is more stable than the PVA in size and against strain or wear, as protective film for the basic material film. PVA (polyvinylalcohol) film, which is only dyed with iodine and treated with polarizer is extremely weak in resistance against both water and wear, and so it is used only after lamination with CTA on both sides like CTA/PVA/CT. Yet such polarizing cellulose acetate films are in thin sheets, and are mainly used for industrial purposes in computers, liquid crystal gauge boards, liquid crystal display screens for hand-carried phones, etc., and if only rarely for polarizing sunglass lenses of no power, too.

The color-changing lenses for use for the photo-chromic light polarizing sunglasses of power should be laminated on the frontal part, of the positions that above-said CTA (cellulose triacetate) film is laminated on, viz. nearer the source of lights, so that it can fully serve as a photo-chromic material by directly reacting to the radiation of ultraviolet rays. For this purpose, a spiro(indoline)naphthoxazine compound or a spirobenzopyrene compound is dissolved in such an ordinary organic solvent as benzene, toluene, chloro-form, ethylacetate, methylethylketone, acetone, ethylalcohol, methylalcohol, acetonitrile, tetrahydrofuran, dioxane, methylether of ethyleneglycol, dimethylformamide, dimethyl-sulfoxide, methylcellosolve, morpholine, and ethyleneglycol is mixed into a transparent polymer, copolymer, or a mixture of transparent copolymers, whose names will be given below; is hardened into a photo-chromic material; and is laminated into layers of a transparent copolymer and a mixture of transparent copolymers, e.g. in the fashion of MMA/PVA/MMA (methyl methacrylatemethyl), instead of the former layers of CTA/ PVA/CTA. At this time, to elaborate, the lamination is to be so done that the mixture of the transparent copolymer and transparent copolymer mixed with a photo-chromic material, e.g. MMA will come to the frontal part (layer) nearer the source of light, so that it can fully fulfill its role as photo-chromic material. The ultraviolet rays that penetrate later will be blocked by the absorbent mixed in the mixture of transparent copolymers and transparent copolymers, e.g. MMA, laminated on the rear layer, the farthest from the source of light.

The materials to make a photo-chromic lens by getting mixed into a spiro(indoline) naphthoxazine compound or a spirobenzopyrene compound for application to the photo-chromic light-polarizing sunglass lenses of power, of the present invention, include, for example, polymers of polyol(arylcarbonate) monomers, polyacrylate, poly(alkylacry-late), e.g. polymethylmethacrylate (MMA-methyl methacrylate), polycarbonate, poly-ethylene terephthalate, polystyrene, poly(styrene-methyl methcrylate copolymers, poly(styrene-acrylonitrile) copolymers, and polyvinyl butyral. Transparent copolymers and mixtures of transparent copolymers are also suitable.

Preferable for application to are optically transparent polymeric organic materials made from such polycarbonates as poly{4,4-dioxydiphenyl-2,2-propane (on sale on the mar-ket as LEXAN)}; polymethylmethacrylate (on sale as PLEXIGLAS); copolymers of polyol(arylcarbonate) (on sale as CR-39), particularly diethyleneglycol bis(aryl carbonate) and, e.g. vinyl acetate and its copolymers, e.g. 80%˜90% diethylene glycol bis(aryl carbonate) and 10%˜20% vinyl acetate copolymers; in especial, 80%˜85% bis (aryl carbonate) and 15%˜20% vinyl acetate.

Of the materials to make a photo-chromic lens by mixing into a spiro(indoline)naph-thoxazine compound or spirobenzopyrene compound for the purpose of application to the photo-chromic light-polarizing sunglass lenses of power, of the present invention, the polyol(aryl carbonate) which can be polymerized to form transparent photo-chromic lenses is the polyol carbonate of either aliphatic or aromatic liquid polyol with a straight chain or a branched chain, e.g. an aliphatic glycol bis(aryl carbonate) compound or an alkylidene bisphenolbis(alkyl carbonate) compound. These monomers can be described as polyol, e.g. unsaturated poly carbonate of glycol. The monomers can be produced by a method publicly known in this field, e.g. those disclosed in U.S. Pat. Nos. 2,370,567 and 2,403,113.

Now light-polarizing sunglass lenses, too, like ordinary colored sunglass lenses, inevitably have to undergo the process of getting the PVA dyed with a certain thickness of iodine, but as a result of such a dyeing treatment a chromaticity is fixed, entailing a phenomenon that indoors or in a tunnel objects look dark and gloomy, through such lenses.

To remedy this sort of defects of the existing sunglasses the present invention provides a photo-chromic lens, in which, basically, the PVA which serves as polarizer is dyed sufficiently thinly at the time of the dyeing treatment, lest objects should be seen dark or gloomy indoors, and a transparent copolymer or a mixture of copolymers mixed with a certain amount of photo-chromic materials which can react to ultraviolet rays and darken objects in bright sunlight, e.g. MMA (methyl methacrylate) or the like, is laminated with in the front (layer) nearer the source of light to render the color thicker when ultraviolet rays irradiate.

Meanwhile, although a photo-chromic light-polarizing lens has far better functions and far greater capacities than ordinary sunglasses by virtue of its built-in polarizer of the form of a perpendicular reticulum, which can shut out the dazzling traverse waves of interfering rays shot from the roads, vehicles, and other reflectors, hardly blocked off by ordinary sunglasses, no method has so far been proposed for mass production of such photo-chromic polarizing sunglasses of power suitable for weak-sighted people for supply at reasonably cheap prices.

Until present plain polarizing sunglasses of no power have easily been produced, but for weak-sighted people it has been difficult to acquire polarizing sunglasses of power. Although polarizing sunglasses have outstanding effects of blocking dazzling reflected light, there have not as yet been instances of a method being disclosed for mass production of polarizing sunglasses of power to offer such glasses at reasonably cheap prices.

Plain polarizing sunglasses of no power have been produced by various methods and the products are merchandised at relatively cheap prices. To the weak-sighted, who, have to wear glasses for all time, too, thick sunglasses are available, but these sunglasses are invariably incapable of blocking the dazzling reflected lights.

Attempts to provide polarizing lenses for the weak-sighted have been possible only with glass lenses, and, moreover, because of the difficulty in grinding and polishing glass almost forbiddingly high prices can purchase the desired products for the present. Practically the only way for a weak-sighted person to wear polarizing sunglasses is just to clip two such eye glasses on his everyday thick spectacles.

In polarizing lenses, either polarizing cellulose acetate film material or films of the group of polyvinyl alcohol (PVA), which either contain iodine or have dye of different colors fixed on them, are well known as polarizing films. Polarizing films of this ordinary sort are excellent in polarizing functions, but not so in their resistance against water and moisture. To remedy this defect, lamination with a protective film having cellulose acetate as its basic material has been proffered, and actual products are on the market. But these are in sheets of thin membrane, and so it is impossible to materialize power on them. They are too poor in permeability of light for use for ophthalmic lenses, relatively soft and consequently apt to get scratch, wherefore, they are not suitable as material stuff of ophthalmic lenses, but normally are in use for computers, liquid crystal gauge displays, hand-carried phone displays, etc. At times they are in use as material stuff of light-polarizing sunglass lenses of no power.

Light-polarizing glass lenses are hard and strong against scratches, because both the surfaces which envelop the light-polarizing plate is glass and not acetate film, but the feel of wear is anything but very pleasant. As their weights per surface area are greater than in the case of ophthalmic plastic lenses, they have various relative disadvantages such as, for instance, heaviness and discomfort on the part of the users, while, owing to the physical properties as glass larger lenses cannot be provided.

But if light-polarizing glass lenses are ground and polished on the grinder with an optician's, it will be possible to obtain glass lenses of a desired power. But this will incur the user heavy charges of grinding fees, and the resultant glass lenses, heavier than plastic lenses in weight, are of less comfort to wear.

Despite the fact that light polarizing sunglasses have far outstanding functions and effects than ordinary sunglasses there never have been provided methods for mass production of light-polarizing sunglasses of power for supply at reasonably cheap prices, and to fill this need the present invention was conceived of and has now been completed. By the present invention mass production, with ease and simplicity, of photo-chromic light-polarizing sunglass lenses of desired power has become possible. Mass production will make the products available to all the many who need them in the whole world at far lower prices than at present.

### BRIEF DESCRIPTION OF DRAWINGS

FIG. 1 is the sectional view of the laminated layers of a photo-chromic light-polarizing sunglass lens of power, of the present invention.

FIG. 2 is the perspective view of a molding flask for production of the light-polarizing lens plate in the present invention.

FIG. 3 carries the perspective and sectional views of the clamp for pressing the light-polarizing lens plate and no-power lens plate in the present invention.

FIG. 4 is the perspective view of the laminated layers of a photo-chromic light-polarizing lens plate, of the present invention.

FIG. 5 is the front view showing the indices of a polarizer of each mold to its refraction in the vertical axial direction.

FIG. 6 shows the form each of the convex and concave molds of the bending mold for the formation of the curved surfaces of the sunglass lenses.

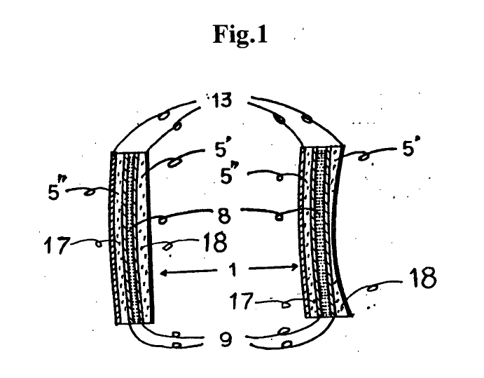

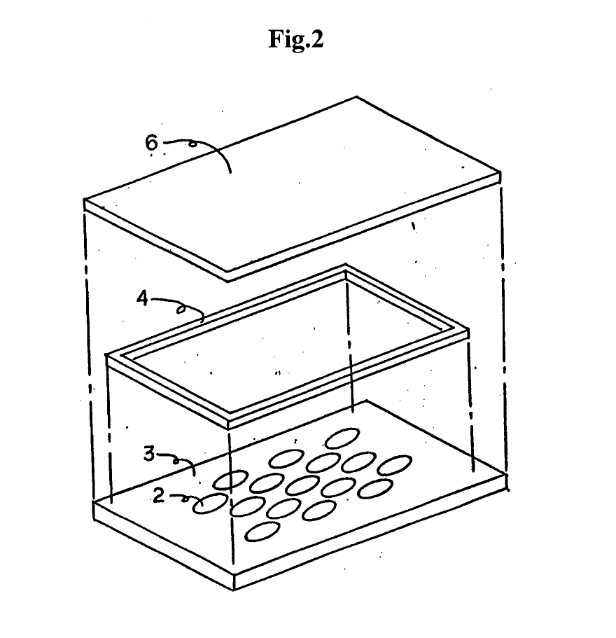

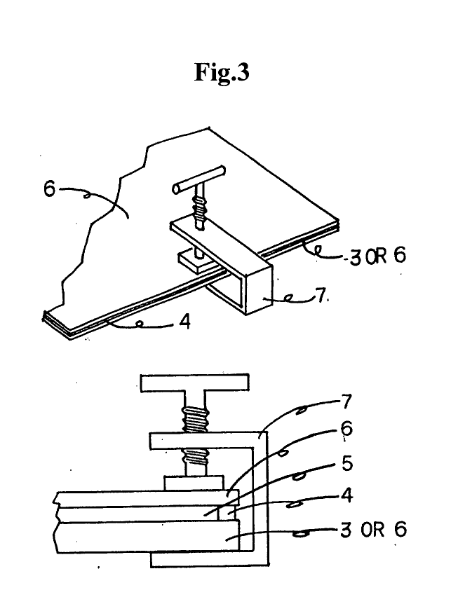

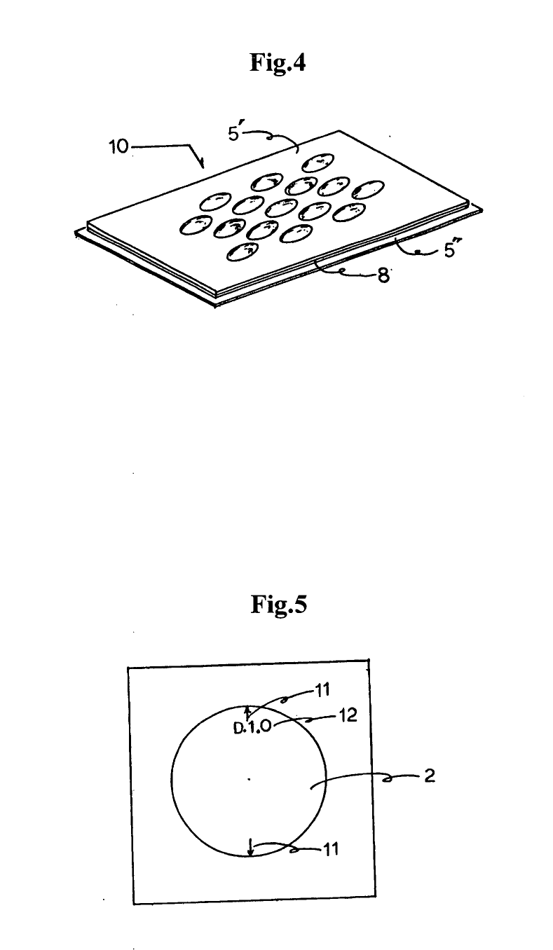

### MOST PREFERABLE EMBODIMENTS OF INVENTION

The method for production of lenses for the photo-chromic light-polarizing sunglasses of power comprises of:

Step 1: extending PVA (polyvinylalcohol), dyeing it with iodine, fixing the iodine particles on the PVA film in a water solution of boric acid, drying, and thus obtaining the polarizer 8;

Step 2: producing, from a transparent copolymer or a mixture 5 of transparent copolymers, a lens plate 5′, which carries from a mere few to scores of lenses of different powers;

Step 3: producing a photo-chromic no-power lens plate 5″ by means of mixing a spiro(indoline)naphthoxazine compound or a spirobenzopyran compound 17 into a compound of the said transparent copolymer or their mixture 5;

Step 4: applying a treatment of rolling adhesion to the said polarizer 8 from Step 1 and the said no-power lens plate 5″ from Step 3 with ultraviolet ray hardening resin 9 or an adhesive;

Step 5: applying a treatment of rolling adhesion to the surfaces of the said polarizer 8 from Step 4 and the said power lens plate 5′ from Step 2 with ultraviolet ray hardening resin 9 or an adhesive, and thus completing a lamination plate 10 carrying from a mere few to so many as scores of photo-chromic light-polarizing sunglass lenses of power arranged on it; and,

Step 6: doping both sides of the lamination plate 10 of photo-chromic light-polarizing sunglass lenses of power which has come out of Step 5 above with a hard coating preparation 13 to give it a protective cover against scratches, drying it, and applying to it a treatment of bending to give it curved surfaces for sunglass lenses.

Below, the method for production in the present invention is described step by step in further detail.

The examples of embodiment of the present invention are as given below, but it is only too natural that the present invention shall not be taken as confined to these given examples alone, for persons even ordinarily skilled in the art could easily choose a number of variations or modifications within the reach of the rights of the present invention.

### EXAMPLES

### Example 1

[Formation of Polarizer]

A light-polarizer is produced by, first, giving PVA film of about 75˜95 μm a treatment of swelling in hydrogen at 30˜50° C.; extending it to three to eight times, whereby the constituent molecules of the PVA are oriented linearly in a direction; getting it well soaked in a water solution of iodine at 0.5˜5% so that the PVA film can be dyed with iodine molecules; and, next, by fixing the dyeing iodine particles on the PVA film by soaking it in a direction in a water solution of boric acid at 3˜4% at 25° C.˜50° C. for 1˜4 minutes; and finally drying it.

### Example 2

[Production of a Power Lens Plate]

A mold base 3, which carries from a mere few to so many as scores of convex and concave lens molds 2 for various diopters, is made from a heatproof plate glass; it is doped with a sealant 4; and then it is filled with the afore-said transparent copolymer or a mixture 5 of such transparent copolymers mixed with an ultraviolet ray absorbent.

The mold base 3 is covered by another heatproof plate glass 6; a clamp 7 so fastens them that they do not leak the mixture of transparent copolymer 5 inside; said mixture is let to harden to obtain a power lens plate 5′ carrying a few to scores of transparent power lenses; the plate which provides a surface to get laminated with the said light-polarizer 8. The thus acquired power lens plate 5′ is at least 0.4 mm thick to any thickness which can offer each required diopter.

For the mold base 3 for production of a power lens plate 5′ carrying a few to scores of molds 2 for the concave and convex lenses arranged on one plate, heatproof ceramic or metal may also be used in lieu of heatproof plate glass, if it is so preferred.

### Example 3

[Production of a No-Power Lens Plate to Manufacture Photo-chromic Lenses]

A spiro(indoline)naphthoxazine compound or a spirobenzopyrene compound 17 is dissolved either in such an ordinary organic solvent as benzene, toluene, chloroform, ethyl acetate, methylethyl ketone, acetone, ethyl alcohol, methyl alcohol, acetonitrile, tetra-hydrofuran, dixoane, methylether of ethyleneglycol, dimethylformamide, dimethyl sul-foxide, methylsolosolve, morpholine, and ethylglycol, or in a solution of the trans-parent host copolymer dissolved in one or more of the organic solvents mentioned above, e.g. polyvinyl acetate-acetone solution, nitrocellulose-acetonitrile solution, polyvinyl chloride-methylethylketone solution, polymethyl methacrylate-acetone solution, cellulose acetate-dimethylformamide solution, polyvinylpyrolidone-acetonitrile solution, polystyrene-benzene solution and ethylcellulose-methylchloride solution, while stirring at normal temperature; it is mixed into the said copolymer and a mixture 5 of the said transparent copolymers at about 0.01˜20 wt %, normally 0.05˜10 wt %; stirred with a stirrer so that the mixture may be thoroughly dispersed; it is then filled in the said mold after a sealant 4 is doped on a heatproof plate glass 6; the said plate is further covered with another heatproof plate glass 6; the compound is hardened while the plate glasses are pressed ed by a clamp 7 to get fastened so that the content may not leak from; this way a plain no-power photo-chromic lens plate 5″ is made to provide the other end surface for lamination to acquire the light-polarizer 8 in Example 1. The size will be slightly larger than in Example 2 in both lateral and vertical directions, the thickness perhaps be made into about 0.2˜1.0 mm for a better processability, and thus it being possible to acquire a photo-chromic sunglass power lens 1 of a lighter weight.

### Example 4

[Adhesion of a No-Power Photochromic Plate to a Light-Polarizer]

Between the said no-power photo-chromic lens plate 5″ and the said light-polarizer 8 in Example 1, ultraviolet ray-hardening resin is injected in; these are passed through a pressure roller, and the adhesion is completed by hardening by irradiation with ultraviolet rays. The wave length of the ultraviolet rays used in this particular case is preferably 250˜350 mm, the distance between the source of the ultraviolet rays and the plate sufficiently 5˜25 cm, the time of exposure possibly varying according to the different compositions of the ultraviolet ray-hardener, but 5˜20 minutes being just about adequate.

### Example 5

[Completion of Laminated Plate of Light-Polarizing Lenses of Power]

A laminated plate of photo-chromic light-polarizing sunglass power lenses 10 carrying from a mere few to so many as scores of lenses arranged together is completed first by injecting in ultraviolet ray-hardening resin 9 between the surface of the said light-polarizer 8 from Example 4 and the flat surface of the power lens plate 5′ from Example 2, and next by adhering them by irradiation with ultraviolet rays as in Example 4.

### Example 6

[Hard Coating of Both Surfaces and Bending of Them for Formation of Curved Lens Surfaces]

To prevent scratching of the laminated photo-chromic light-polarizing sunglass power lens plate 10 produced in the way given above, a hard coating preparation 13 is applied to both surfaces of the plate; the plate is given a decompression desiccation treatment in an oven, before getting placed in a bending process to bestow curved surfaces upon the plate for serving as sunglass lenses. But, when the plate is mounted on the press bending mold, it was seen to it that a no-power plate 5″ is placed on the lower side of the mold, so that it will find its place in the frontal part of the sunglasses, nearer the source of light for the wearer.

The thus produced laminated plate 10 carrying from a mere few to so many as scores of photo-chromic light-polarizing power lenses will easily break if it is, as it is, bent, and so to prevent this it is heated, as a preliminary stage, in a chamber whose internal temperature is kept at 70° C.˜120° C. for about 5˜25 seconds, and then it is placed in a press bending mold, whose female mold 14 and male mold 15 are fixed to the proper lens curves 16 (generally, 6.00˜8.00) to get each part of Mold 2 pressed by each male mold 15 in the direction of A and made to have a sunglass lens curve and cooled, while each is thereby completed into a photo-chromic light-polarizing sunglass lens 1 of a desired power.

Of these various process steps, those for Example 1 can be preformed by commonly known practices, but in those of Example 2 it is necessary to mark the vertical axis indication 11 on each convex and concave lens mold in relief or else by incision, for it will be impossible to perform sunglass lens processing in the absence of the exact knowledge of the polar axes. For the light-polarizing power lenses 1 completed through Example 6 to be made into a pair of sunglasses it is also necessary to have its polar axes marked in relief or by incision, and so are the FIG. 12 to indicate the particular power of each individual lens in a similar fashion. This way, even if the completed sunglasses should be mixed with others while in circulation or storage, the devices would help their search and distinction.

In order to acquire a certain degree of adhesion as well as a certain thickness in the process of tight adhesion in Examples 4 and 5, the laminated plate is passed through a pair of rollers, arranged one above and the other, below. But if, at this time, the varying power lens molds 1, engraved in the mold base 3 in Example 2 be aligned in the horizontal and vertical directions, some gaps may possibly occur between the above and the below because of the deflection caused at the time when the rollers pass the high points and low points of the lenses, and to prevent this it is also possible to align the varying power lens molds 2, engraved in the mold base 3, lozengewise in the lengthwise direction, whereby a stability in height is secured while in the rolling process.

Industrial Applicability

The present invention is intended to provide sunglasses which can shut out the dazzling reflection lights and yet prevent the uncomfortable darkening phenomenon even in a tunnel or the like, by means of making ordinary light-polarizing lenses and conventional photo-chromic lenses mutually offset their defects and enhance their merits.

By making use of the characteristics of blocking the intrusion of the dazzling polarized reflective and refrangible interference rays from the roads, vehicles, and other reflectors in the sunlight, which ordinary sunglasses or conventional photo-chromic sunglass lenses cannot block, and again making most of the photo-chromic characteristic of get-ting thicker in color in the open, where ultraviolet rays in the bands of 200˜380 nM in wavelength shine, in reaction to them, but reverting to its original thin color indoors or inside a darker tunnel, for instance, the present invention has produced a sunglass lens, in which, the PVA to serve as the light-polarizer is basically dyed in thin hues in the stage of dyeing so that man can indoors see through it objects clearly, and which is laminated, in its frontal layer nearer the source of light, with a transparent copolymer or a mixture of such copolymers, [say, e.g. MMA (methyl methacrylate)] so that it may get darker in reaction to ultraviolet rays in the open, whereby the product can serve as a real photo-chromic sunglass lens. Because the sunglasses with lenses of the present invention can help the wearer see things light enough indoors or inside a tunnel and yet see things darker in the sunshiny outdoors, a driver will no longer need to take his sunglasses off when entering into a tunnel, which he wore while driving in the shining sunlight, thus bringing forth a greater convenience, safety, and all.

Never has there been an instance before in which a photo-chromic light-polarizing power lens for sunglasses and a method for its production were proposed.

As to plain no-power light-polarizing sunglasses many kinds of them have been produced and placed on sale for relatively low prices. Meanwhile, people of weak sights, too, can use powered sunglasses, but powered light-polarizing sunglasses that can block reflective lights are rarely available. Attempts to provide the weak-sighted with powered light-polarizing sunglasses have also been made but they have been confined to the use of glass as material. It is possible as a matter of course to produce sunglasses of required power by grinding and polishing light-polarizing glass on a grinder with an optician's, but this will incur a weak-sighted person a forbidding price, and it is uncomfortable to wear such because they are heavy in weight, compared with those of plastic material. Because of the high prices due to the fees for the painstaking labor of grinding the weak-sighted persons are subjected to a practice of wearing no-power sunglasses over their powered everyday glasses, clipping the former on the latter.

Despite the fact that the light-polarizing sunglasses far excel the ordinary ones in functions there have been no way suggested so far of offering weak-sighted persons powered light-polarizing sunglasses at reasonably low prices, and now the present invention provides a way of mass production of such photo-chromic light-polarizing sunglasses of power, which will certainly make such sunglasses, lighter than those of glass material, and, therefore, very comfortable to wear, available to the weak-sighted in the whole world at incomparably lower prices than at present.

1. A photo-chromic light-polarizing sunglass lens of power and a method for its production, wherein the said sunglass lens is made:
first by attaining, for lamination with a light-polarizer, one side surface by making from heatproof plate glass a mold base having from a few to scores of molds for convex and concave lenses of various degrees of power to meet power lenses of various degrees of power; doping its edges with a sealant; filling it with a transparent copolymer or a mixture of transparent copolymers mixed with ultraviolet ray-absorbent; covering it with another heatproof plane glass; fastening them with a clamp so that they do not leak the transparent copolymer or the mixture of transparent copolymers; hardening said contents; and thereby producing a transparent power lens plate having a few to scores of transparent power lenses arranged on it;
next by attaining, for lamination on the light-polarizer in Example 1, another side surface by dissolving a compound of spiro(indoline)naphthoxazine, spirobenzopyrene, spiro(indoline)pyridobenzoxazine, spiro(benzindoline)pyridobenzoxazine, spiro(indoline) ben-zoxazine, spiro(indoline)benzopyran, spiro(indoline)naphthopyran, spiro(indoline)qui-nopyran, apiro(indoline)pyran, 3H-naphtho[2.1-1b]pyran, 2H-phenantro[4,3-1b]pyran, 3H-phenantro[1,2-1b]pyran, or benzopyran in either such ordinary organic solvent as benzene, toluene, chloroform, ethyl acetate, methylethylketone, acetone, ethyl alcohol, methyl alcohol, acetonitrile, tetrahydrofuran, dioxane, methylether or ethylglycol, di-methylflrmamide, dimethylsulfoxide, methylcellosolve, moropholine, and ethylenegly-col or in such a transparent host compound solution dissolved in one or more of the above-said organic solvents, as, for example, polyvinyl acetate-acetone solution, ni-trocellulose-acetonitrile solution, polyvinyl chloride-methylethylketone solution, poly-methyl methacrylate-acetone solution, cellulose acetate-dimethyl formamide solution, polyvinylpyrolydone-acetonitrile solution, polystyrene-benzene solution and ethylcellu-lose-methylchloride solution, while stirring; mixing the solution in a transparent copol-ymer or a mixture of transparent copolymers at about 0.01˜20 wt %, ordinarily 0.05˜10 wt %; thoroughly stirring in a stirrer to ensure a sufficient dispersion; filling it between a heatproof plate glass having a sealant applied to and another heatproof plate glass; having the two glass plates tightly fastened to each other with a clamp lest any of the contents should leak; hardening the contents; thereby making a transparent photo-chromic no-power plate; then by injecting in ultraviolet ray-hardening resin between the said photo-chromic no-power plate and the said light-polarizer; passing the said plate and polarizer through pressure rollers; irradiating them with a ultraviolet ray of 250˜350 nm; thereby hardening the said resin and thus completing the desired adhesion of them; then tossing in ultraviolet ray-hardening resin between the light-polarizer and the flat surface of a power lens plate, in which a few to scores of transparent power lenses are aligned; passing them through pressure rollers; adhering them by irradiating them with an ultra-violet ray of 250˜350 nm; thus completing a photo-chromic light-polarizing power lens lamination plate which has a few to scores of photo-chromic light-polarizing power sun glass lenses aligned on it;
then by doping the said photo-chromic light-polarizing power sunglass lens lamination plate with a hard coating preparation on both sides to prevent them from getting scratched; giving a decompression desiccation treatment; preheating it in a chamber at 70°·120° C. inside for about five to 25 seconds; placing it between male and female press bending molds with curved surfaces respectively for the degrees of curve (generally of the basic curve of 6.00˜8.00) adequate for sunglass lenses so that by virtue of the press bender the lens on each mold will get pressed to bend to each decided degree of curve; then cooling the plate finally to be completed into a plate of so many orderly aligned photo-chromic light-polarizing sunglass lenses of various power values.

2. The photo-chromic no-power light-polarizing sunglass lens according to claim 1, wherein the photo-chromic light-polarizing power sunglass lens plate has entirely no power diopter.

3. A photo-chromic light-polarizing powered sunglass lens and a method for its production according to claim 1, wherein each photo-chromic light-polarizing power sunglass lens has an indicator to show the direction of its vertical axis and an indicator of its particular power figure either by incision or in relief, respectively on the upper and lower ends.

4. A photo-chromic light-polarizing powered sunglass lens and a method for its production according to claim 1, wherein the mold base for production of the power lens plate having from a mere few to so many as scores of convex and concave molds aligned on it, is made in the fashion of an injection metal mold.

5. A photo-chromic light-polarizing powered sunglass lens and a method for its production according to claim 1, wherein the mold base for production of the power lens plate having from a mere few to so many as scores of convex and concave lenses aligned on it, is made of heatproof ceramic.

6. A photo-chromic light-polarizing powered sunglass lens and a method for its production according to claim 1, wherein the transparent copolymer or the mixture of transparent copolymers is optically transparent copolymer or a mixture of transparent copolymers, selected from a group indispensably comprising polyol(alkyl carbonate copolymer, polyacrylate, poly(alkylacrylate), polymethylmethacrylate (PMMA-polymethylmethacrylate), methylmethacrylate (MMA-methyl methacrylate), polycarbonate, polyethylene terephthalate, polystyrene, poly(styrene-methyl methacrylate) copolymer, poly(styrene-acrylnitrile) copolymer, and polyvinylbutyral.
